(19) United States
(12) Patent Application Publication
(10) Pub. No.: US 2008/0060683 A1
(43) Pub. Date: Mar. 13, 2008

(54) APPARATUS AND METHODS FOR CLEANING A WAFER EDGE

(76) Inventors: Aaron W. Arvidson, Kalispell, MT (US); John Ghekiere, Kalispell, MT (US)

Correspondence Address: PERKINS COIE LLP/SEMITOOL, PO BOX 1208, SEATTLE, WA, 98111-1208, US

(21) Appl. No.: 11/530,345

(22) Filed: Sep. 8, 2006

(51) Int. Cl. C23G 1/00; B08B 7/00; B08B 3/00

(52) U.S. Cl. 134/33; 134/34; 134/94.1; 134/2; 134/149; 134/137

(57) ABSTRACT

Apparatus removes contaminants from edge areas of a wafer by spinning the wafer. Nozzles spray or jet fluid onto both the first and second sides of the wafer, near the edge of the wafer. Typically the spray or jet is at an acute angle to the wafer surface. Contaminants are removed and re-deposition of removed contaminants is reduced or avoided. The nozzle locations and angles may be varied to change the areas on the wafer cleaned by the sprays or jets.

### BACKGROUND

Large numbers of semiconductor components are used in virtually all modern electronic appliances and devices. These components are usually manufactured from flat round disks or wafers of silicon or similar materials. At various steps of the manufacturing process, contaminants may be formed or deposit on the wafer. The contaminants may be by-products of the manufacturing process, such as films or particles of polymers, photoresists, metals, etc. These contaminants generally must be removed or cleaned away before further processing. In the past, contaminants have been removed by spraying a cleaning liquid onto a spinning wafer. High pressure spraying has also been used. However, while these processes may be effective in initially removing contaminants, the contaminants can redeposit elsewhere on the wafer. For example, cleaning a front side of a wafer using a high pressure spray can cause contaminants removed from the front side to redeposit onto the back side of the wafer. Accordingly, improved wafer cleaning and processing methods and apparatus are needed.

### SUMMARY

Novel apparatus and methods for removing contaminants from a wafer have now been invented. Recognizing the problems with existing techniques, the inventors have developed new ways for removing contaminants which are highly effective, yet relatively simple to perform. In one aspect, an apparatus for removing contaminants may include a rotor for spinning a wafer. A first nozzle may be aimed to spray a first fluid at a location on the wafer, generally near the edge on a first side of a wafer, and in a direction away from the spin axis. A second nozzle may be aimed to spray a second fluid at the location, on a second side of the wafer, and also in a direction away from the spin axis. By spraying onto both the first and second sides of the wafer, contaminants are removed and re-deposition of removed contaminants is reduced or avoided. The invention resides in the method and apparatus described here, and in sub combination of them.

### BRIEF DESCRIPTION OF THE DRAWINGS

In the drawings, where the same reference number indicates the same element, in each of the views.

FIG. 1 is a side view of a first embodiment.

FIG. 2 is a top view of a second embodiment.

FIG. 3 is an enlarged section view taken along line 3-3 of FIG. 2.

FIG. 4 is a section view of a fourth embodiment.

FIG. 5 is a diagram of a nozzle arrangement for providing edge area or margin.

FIG. 6 is a diagram another nozzle arrangement.

### DETAILED DESCRIPTION OF THE DRAWINGS

A bottom jet or spray of fluid is directed at the edge of a bottom or back side of a wafer. A top jet or spray of fluid is directed at the edge of the front or top side of the wafer. The fluid removes contaminants which may be carried away in the fluid stream. The bottom and top sprays of fluid may be substantially angularly aligned, so that the spray from the bottom and top nozzles impinge on the same general area or sector of the wafer. The fluid flow on the top of the wafer helps to prevent re-adhesion or re-deposition of contaminants removed from the bottom of the wafer onto the top of the wafer. Similarly, fluid flow on the bottom of the wafer helps to prevent re-adhesion or re-deposition of contaminants removed from the top of the wafer onto the bottom of the wafer. The specific positions, angles, velocity, physical and chemical properties, of the top and bottom sprays may be varied.

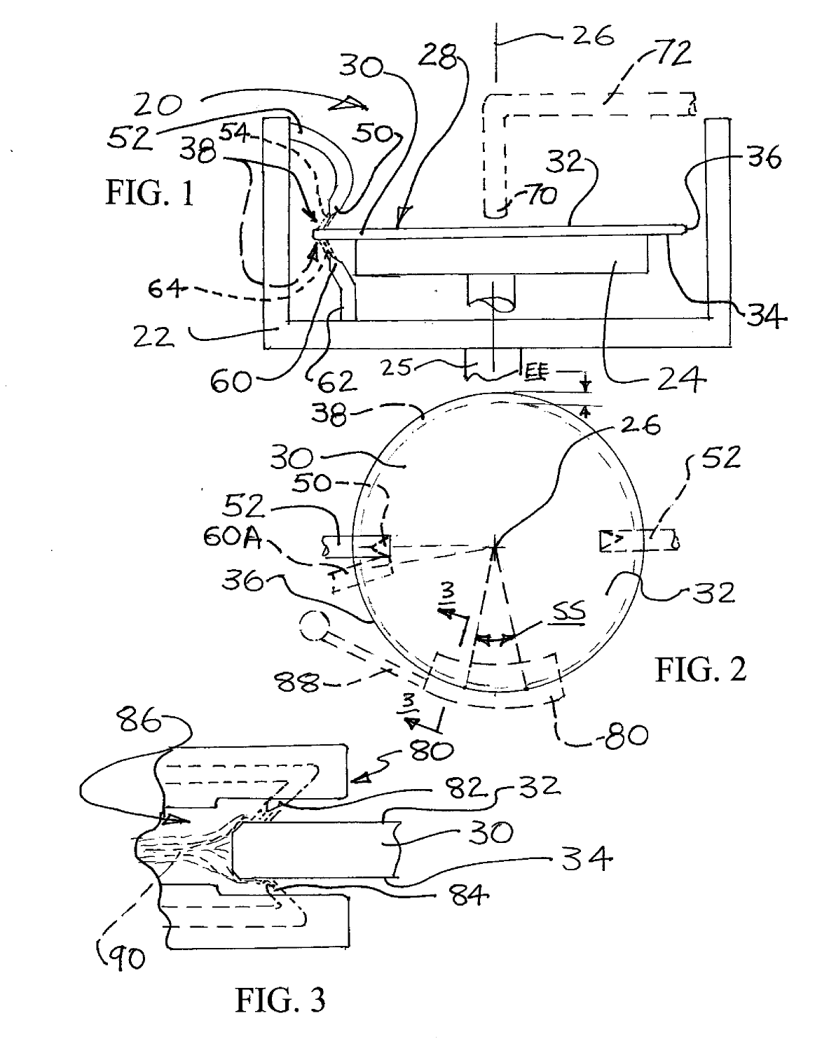

Turning now in detail to the drawings, in one form, as shown in FIG. 1, a processor 20 includes a rotor 24 which may be positioned within a base or bowl 22. The rotor 24 is rotatable about spin axis 26. In the design shown in FIG. 1, the spin axis is generally vertical. In other designs, the spin axis 26 may be horizontal or at an intermediate angle between vertical and horizontal. The rotor 24 is connected directly or indirectly to a motor 25 which spins the rotor 24. The motor 25 may be below the rotor 24, as shown in FIG. 1, above the rotor 24, or at another position.

A wafer holding position 28 is provided in or on the rotor 24. Typically, the rotor 24 has elements for supporting and holding a wafer 30. These elements may be pins, standoffs, clamps, fingers and similar mechanical elements. These elements may also be suction or vacuum elements, which hold the wafer 30 via gas or air pressure effects, including venturi effects. FIG. 1 shows a wafer 30 in the wafer holding position 28 on the rotor 24.

The wafer or workpiece 30 is shown as round and flat, and has a top or front surface 32 (typically the device or active side), a bottom or back surface 34, and a circumferential edge 36. Referring momentarily to FIG. 5, the wafer 30 typically also has bevel surfaces 40 between the edge 36 and the top and bottom surfaces. The wafer 30 may optionally be in the form of a D-shape, with a flat edge, as provided by semiconductor manufacturing industry standards.

Referring still to FIG. 1, an upper edge liquid outlet or nozzle 50 is supplied with liquid from a supply line 52. An upper liquid Jet or spray 54 emitted from the nozzle 50 is shown in dotted lines in FIG. 1. A lower edge liquid outlet or nozzle is supplied with liquid from a supply line 62, with a lower liquid jet or spray 64 also shown in dotted lines in FIG. 1. The nozzles 50 and/or 60 may be supported on a supply line such as 52 or 62, or they may be supported on, or located in, other components or structures. The nozzles 50 and/or 60 may be fixed in position, as shown in FIG. 1, or they may be moveable so that they may be placed into an appropriate position before processing begins.

Alternatively, the nozzles may be moved as desired during processing. Nozzle movement, if used, may be used to change the vertical spacing between the nozzle and the wafer, or to change the angle of incidence at which the liquid impacts onto the wafer, or to change where on the wafer the liquid emitted from the nozzle impacts onto the wafer, or combinations of these changes. Accordingly, nozzle movement, if used, may be angular or aiming movement, or it may be translational movement, in one or more of three dimensions.

As shown in FIG. 1, a centrally located nozzle or outlet 70 may also be used to deliver a liquid or a gas at or near a central location of the wafer. If used, the central outlet may be positioned to deliver a liquid or a gas to the top surface 32 or the bottom surface 34 of the wafer 30, or to both surfaces. The nozzle 70 may be fixed in position, or it may be on a moveable support, such as a swing arm 72.

In an alternative design as shown in FIGS. 2 and 3, one or more upper nozzles 82 and lower nozzles 84 may be provided in a manifold 80 overlying an edge of the wafer 30. The manifold 80 may have a drain opening 86 generally aligned with the edge of the wafer, to allow liquid 90 to flow freely off of the spinning wafer. The manifold 80 may optionally be supported on a swing arm 88, or other manifold moving device, such as a linear actuator. This allows the manifold to move between a process position, as shown in FIG. 2, and a load/unload position, where the manifold is moved away from the wafer. In the load/unload position, with the manifold spaced apart from the wafer, the wafer may be lifted and lowered vertically onto the rotor 24.

The features described above with reference to FIG. 1 may also be used in the manifold design shown in FIGS. 2 and 3. The nozzles or outlets, in either design, may be cone, fan, jet, or other types of outlets. References here to the angle or direction of the spray or jet refer generally to the center axis of the spray. The nozzles 50 and 60 or 82 and 84 may be arranged to spray liquid onto a sector SS of the spinning wafer 30. The sector SS may vary from a few degrees up to about 90 degrees or more, with sectors of about 10 to 45 degrees used in typical applications.

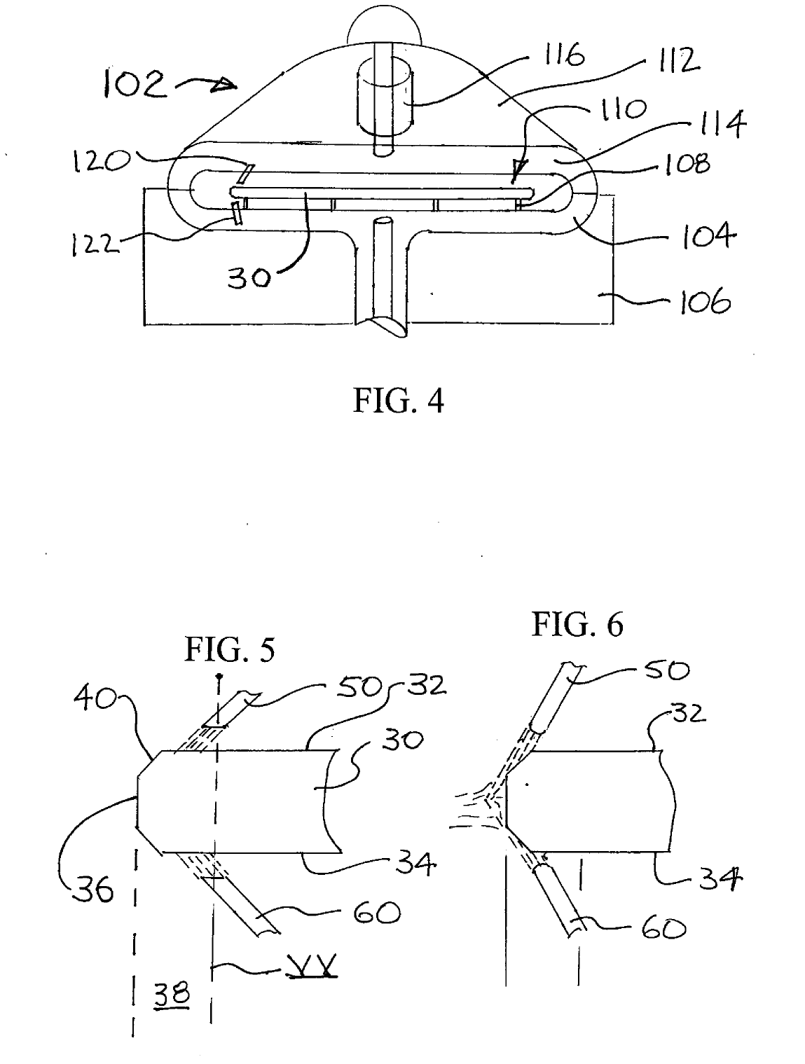

FIG. 4 shows another alternative design having upper and lower edge nozzles 120 and 122 which may be similar to the upper nozzles 50 and 82 and the lower nozzles 60 and 84 as described above, in a processor 102 as described for example in U.S. Pat. No. 6,632,292, incorporated herein by reference. In this design, one or more upper nozzles 120 are in or on an upper rotor 114, and one or more lower nozzles 122 are in or on an lower rotor 104. The rotors may be engaged together to form a processing chamber 110 between them. The wafer 30 is supported within the process chamber 110, for example on pins or standoffs 108. A motor 116 in a head 112 is linked to the upper rotor 114. A base 106 may be provided under or around the process chamber 110, to collect and drain process liquids or gases.

In use, the rotors are separated from each other. A wafer is loaded into the processor 102, typically via a robot, by placing the wafer onto the pins 114 or other supporting element. The upper and lower rotors are then brought together to form the processing chamber. The upper rotor is then physically connected or engaged with the lower rotor. A motor 116 which is linked to the upper rotor 114, is turned on. The engaged upper and lower rotors forming the process chamber then spin about a central axis. Liquid supplied from the edge nozzles 120 and 122 process the wafer, as described above.

As shown in FIG. 5, by spraying or jetting liquid (typically at high pressures) onto both sides of the wafer, near the edge of the wafer, can efficiently remove contaminants from the edge. The liquid pressure supplied at the nozzles may typically be about 100-15,000 or 500-2000 psi, and more typically about 400-800 psi. When using a singe orifice nozzle, an orifice diameter of 0.2-10 mm may be used. Liquid impact velocities of 1-100 meters/second may be used. Liquid jets or solid columns of moving liquid may also be used, as described in US Patent Publication No. 2002/0157686, incorporated herein by reference. Steam may be used in place of or in addition to liquid. The liquid may be heated from about 25° C. to about 99° C. at ambient pressures. The wafer may be rotated at about 30-2000 rpm. When liquid is used, the liquid may include de-ionized water. Additives such as HF, HCl or other acids, or bases such as ammonia may be introduced into the water. Surfactants, detergents, solvents, alcohols and co-solvents may also be used, typically mixed into the water. Ozone may also be used, entrained and/or dissolved in the liquid. The process chamber 22 shown in FIG. 1 may be covered or sealed, to prevent free release of gases or vapors from the chamber, and/or to provide a gas (e.g., ozone) environment around the wafer 30 during processing.

As shown in FIG. 5, processing as described above can provide an annular edge margin or zone 38 substantially free of contamination, between the edge 36 of the wafer 30, and the location of the nozzles 50 and 60. In FIG. 5, both nozzles 50 and 60 are shown vertically aligned on axis UV, with the edge zone 38 between the axis VV and the edge 36. However, it is not necessary that the nozzles 50 and 60 be vertically aligned. For example, the lower nozzle 60 may be positioned radially further inwardly (closer to the spin axis 26) in comparison to the upper nozzle 50. Consequently, the annular margin 38 on the bottom surface may be wider than on the top surface, and vice versa. Turning momentarily back to FIG. 2, it is also not necessary that the nozzles 50 and 60 be angularly aligned (at the same azimuth angle). For example, the lower edge nozzle, shown at 60A in FIG. 2, may be radially offset from the upper edge nozzle 50, as may be needed. However, aligning the nozzles may be provide flow characteristics leading to improved results in removing and preventing redeposition of contaminants.

As shown in FIG. 6, the position and angle of the nozzles 50 and 60 may be varied depending on the specific application. In FIG. 6, the nozzles 50 and 60 are primarily directed at the bevel surfaces 40 of the wafer. While the discussion above primarily concerns applying liquid from the nozzles, gases and vapors may also equivalently be used in place of liquid, or in combination with liquid. The term wafer or workpiece here includes semiconductor wafers, flat panel displays, rigid disk or optical media, thin film heads or other workpieces formed from a substrate on which microelectronic circuits, data storage elements or layers, or micro-mechanical or micro-optical elements may be formed. The term spray here includes spraying, flowing, jetting, or otherwise applying one or more liquids, gases or vapors onto a wafer. Singular expressions used here include the plural, and vice versa. References here to top and bottom may of course be reversed, as either side of a wafer may be considered as the top. While the wafers 30 have been shown and described in a horizontal orientation, the present methods and apparatus may also be used with a wafer in a vertical orientation, or at an angle between horizontal and vertical.

Thus, novel methods and apparatus have been shown and described. Various changes may of course be made without departing from the spirit and scope of the invention. The invention, therefore, should not be limited, except to the following claims, and their equivalents.

1. A workpiece processor, comprising:
a rotor rotatable about a spin axis;
a first nozzle aimed to spray a first fluid at a location, adjacent to an edge on a first side of a workpiece on the rotor, in a first direction away from the spin axis; and
a second nozzle aimed to spray a second fluid at the location adjacent to the edge on a second side of the workpiece, in a second direction away from the spin axis.

2. The workpiece processor of claim 1 with the first direction at an angle A relative to the first side of the workpiece and with the second direction at an angle B relative to the second side of the workpiece, and with angle A equal to angle B, plus or minus about 30 degrees.

3. The workpiece processor of claim 1 further comprising a first source of first high pressure liquid connected to the first nozzle, and a second source of second high pressure liquid connected to the second nozzle.

4. The workpiece processor of claim 1 where the first fluid is the same as the second fluid.

5. The workpiece processor of claim 1 wherein the spray of the first fluid has a centerline forming an angle with the first side of the workpiece ranging from about 5-50 degrees.

6. A processor, comprising:
a rotor rotatable about a spin axis;
a workpiece holding position on the rotor;
a first outlet aimed to direct a first fluid along a first axis towards a target location adjacent to an outer edge of the workpiece holding position, with the first axis angled away from the spin axis; and
a second outlet aimed to direct a second fluid along a second axis towards the target location, with the second axis angled away from the spin axis, and with the first axis substantially intersecting with the second axis.

7. The processor of claim 6 with the first and/or the second outlet comprising a high pressure spray nozzle.

8. The processor of claim 6 wherein the second outlet is in a mirror image position of the first nozzle.

9. The processor of claim 6 wherein the first and second nozzles are positioned so that, when a workpiece is placed in the workpiece holding position, the first fluid impacts a first side of the workpiece, adjacent to an edge location on the workpiece, and the second fluid impacts a second side of the workpiece adjacent to the edge location.

10. The processor of claim 6 wherein when a workpiece is placed in the workpiece holding position, the first axis is at a first acute angle to a first side of the workpiece, and the second axis is at a second acute angle to a second side of the workpiece.

11. The processor of claim 6 with the first outlet substantially aligned with the second outlet on a line generally parallel to the spin axis.

12. The processor of claim 6 wherein the spin axis is substantially vertical, and with the first and second outlets substantially vertically aligned with each other.

13. A method for removing material from the edge area of a workpiece, comprising:
spinning the workpiece around a spin axis;
directing a first liquid toward an edge area of a first side of the workpiece, at a first angle relative to the first side of the workpiece;
directing a second liquid toward an edge area of a second side of the workpiece, at a second angle relative to the second side of the workpiece;

14. The method of claim 13 wherein the first and second liquids are provided by spraying.

15. The method of claim 14 wherein the first and second sprays of liquid at least partially intersect each other.

16. The method of claim 14 wherein the first liquid and the second liquid contact the workpiece and then move off of the workpiece in a direction generally perpendicular to the spin axis.

17. The method of claim 14 wherein at least part of the first liquid and at least part of the second liquid combine with each other after contacting the workpiece.

18. The method of claim 13 wherein the first and second liquids are provided from first and second outlets, respectively, located between the edge area of the workpiece and the spin axis.

19. A method comprising:
spinning a wafer around a spin axis;
applying a first stream of a first liquid to an edge area of the wafer on a first side of the wafer, from a first outlet positioned between the edge of the wafer and the spin axis;
applying a second stream of a second liquid to the edge area of the wafer, on a second side of the wafer, from a second outlet positioned between the edge of the wafer and the spin axis;
with the first stream substantially angularly aligned with the second stream.

20. The method of claim 19 wherein the first liquid is the same as the second liquid.

21. The method of claim 19 wherein the first stream and the second stream are directed along a first axis and a second axis, respectively, and with the first and second axes forming an angle AA between them ranging from about 30 to 110 degrees.

22. The method of claim 21 wherein the wafer bisects the angle AA.

23. A workpiece processor, comprising:
spin means for spinning a wafer about a spin axis;
first fluid director means for directing a first fluid toward a target area adjacent to an edge of a first side of the wafer; and
second fluid director means for directing a second fluid toward the target area of a second side of the wafer.
